(19) United States
(12) Patent Application Publication
(10) Pub. No.: US 2014/0124061 A1
(43) Pub. Date: May 8, 2014

(54) Shutter Valve for Pressure Regulation

(71) Applicant: Kyle Patrick Daniels, Coral Gables, FL (US)

(72) Inventor: Kyle Patrick Daniels, Coral Gables, FL (US)

(21) Appl. No.: 13/671,662

(22) Filed: Nov. 8, 2012

(51) Int. Cl. G05D 16/00

(52) U.S. Cl. CPC G05D 16/00
USPC 137/505

(57) ABSTRACT

A valve system designed to regulate the flow of fluids for pressure regulation systems. The valve is defined by a plurality of valve elements in the form of overlapping and interlocking valve blades that can retract and close on command, and defining a central aperture having an adjustable dimension dependent upon the relative positioning of the plurality of valve elements as they are selectively oriented between an open and closed position. The central aperture at least partially defines a free, unobstructed flow path of fluid in pressure regulation applications. The valve system can be driven mechanically or electronically. A mechanical valve control assembly can be comprised of any combination of components that facilitate the operation of said assembly. An electronic control assembly ideally comprises a plurality of sensors each transferring sensor signals to a central processing unit and Shutter Valve driver assembly for purposes of controlling the operation of the pressure regulation system. The central processing unit is interconnected by an activation assembly to the valves so as to regulate the pressure of the system, based on the operational requirements of the pressure regulation system.

### BACKGROUND OF THE INVENTION

1. Field of the Invention

Pressure is the force per unit area applied to an object in a direction perpendicular to the surface. As machines that use pressurized fluid that require regulation have become ubiquitous in today's society, the need to have high performance, low cost and reliable pressure regulation valves is essential. Many pressure regulation valves are variations on themes created many hundreds of years ago, and as such, typically operate with deficiencies in performance and operational life in comparison with Shutter Valves. Shutter Valves are entirely different from any valve ever created and offer unparalleled performance, life and cost effectivity.

Applications

A pressure regulator is a valve that cuts off the flow of a liquid or gas that flows with a certain amount of pressure. Regulators are used to allow high-pressure fluid supply lines or tanks to be operated at safe and/or usable pressures for various applications. An example of this type of valve is a turbine engine external bleed valve to regulate the pressure within the various auxiliary systems used to run aircraft systems.

A typical pressure regulator uses the outside air as a reference for the baseline pressure. It does not typically regulate the pressure difference between the inlet and outlet of a machine, but rather the pressure difference between the inlet of the regulator valve and the ambient conditions.

Other types of pressure regulators cannot or do not require the ambient pressure conditions as a reference. For example, pressure regulators are required to properly control flow from air tanks used for breathing during SCUBA diving. The tank may contain pressures well in excess of 2000 PSI, which could cause a fatal injury to a person breathing it directly. A regulator allows this pressure to be reduced to an amount that is appropriate for breathing.

There are five main types of pressure and they are:

Types of Pressure
1. Explosion pressures
2. Negative pressures
3. Stagnation pressure
4. Surface pressure
5. Fluid Pressure

Shutter Valves are ideally suited as an application of containing explosion pressures in confined vessels, but will work well to regulate pressure of all 5 main categories listed above.

Other applications of the Shutter Valve exist as well. One of these is a relief valve that is a type of valve used to control or limit the pressure in a system or vessel which can build up by an equipment failure, or fire. The pressure is relieved by allowing the pressurised fluid to flow from an auxiliary passage out of the system. The relief valve is designed or set to open at a predetermined pressure to protect pressure vessels and other equipment from being subjected to pressures that exceed their design limits. When the pressure setting is exceeded, the relief valve becomes the path of least resistance as the valve is forced open and a portion of the fluid is diverted through the auxiliary route. The diverted fluid (liquid, gas or liquid-gas mixture) is usually routed through an auxiliary piping system. As the fluid is diverted, the pressure inside the vessel will drop. Once the desired pressure is achieved, the valve can be selectively closed to resume normal operation of the machine. These relief valves are commonly used in turbine engine external bleed piping applications.

Bypass valves are another application that Shutter Valves can be used to protect a pump, gas compressor or any associated equipment from excessive pressure. The bypass valve and bypass path can be internal (an integral part of the pump or compressor) or external (installed as a component in the fluid path). As an example, many fire engines have such relief valves to prevent the overpressurization of fire hoses.

In other cases, Shutter Valves can be used to protect equipment against being subjected to an internal vacuum (i.e., low pressure) that is lower than the equipment can withstand. In such cases, vacuum relief valves are used to open at a predetermined low pressure limit and to admit air or an inert gas into the equipment so as control the amount of vacuum. Shutter Valves can be useful in many applications, including the petroleum refining, petrochemical and chemical manufacturing, natural gas processing and power generation industries.

Brief Summary of Petrochemical Applications

Relief valve (RV): A Relief valve is an automatic device used on a liquid service, which relieves pressure proportionally (slowly) as the increasing pressure needs to be reduced to resume optimal machine operation

Safety valve (SV): automatic system that relieves due to static pressure by a gas. It specifically opens almost straight to a full open after a problem is detected. Safety relief valve (SRV): automatic system that relieves both gas and liquid.

Pilot operated safety relief valve (POSRV): automatic system that relieves system pressure by remote command from an aircraft pilot on which the static pressure (from equipment to protect) is connected.

Low pressure safety valve (LPSV): automatic system that relieves system pressure by static pressure on a gas. The pressure difference is small and is near the atmospheric pressure.

Vacuum pressure safety valve (VPSV): automatic system that relieves system pressure by reducing static pressure on a gas. The pressure is small, negative and near the atmospheric pressure.

Low and vacuum pressure safety valve (LVPSV): automatic system that relieves system pressure by reducing static pressure on a gas. The pressure is small, negative or positive and near the atmospheric pressure.

RV, SV and SRV are currently spring operated in an antiquated fashion. LPSV and VPSV are spring operated or weight loaded, but designs being inferior to the Shutter Valve.

In most countries, industries are legally required to protect pressure vessels and other equipment by using relief valves. Also in most countries, equipment design codes such as those provided by the ASME, API and other organizations like ISO (ISO 4126) must be complied with and those codes include design standards for relief valves.

Whereas pressure relief valves in gas pressure systems are always used to protect the system, in oil hydraulic systems a pressure relief valve can act as part of the control system. The current use of the relief valve is a check valve, a seat with a ball and an adjustable spring. More sophisticated relief valves, such as Shutter Valves are pilot operated, so that the pressure can be set at zero, which is not possible with the current configurations.

Shutter Valves are also ideally suited as blowoff valves, which are used to prevent compressor surge in turbocharged cars. Compressor surge is a phenomenon that occurs when lifting off the throttle of a turbocharged car. When the throttle plate on a turbocharged engine running boost closes, high pressure in the intake system is potentially blocked by the downstream components of the internal combustion engine, which increases wear and can cause expensive damage. This high pressure air naturally travels back to the turbocharger in the form of a pressure wave. This results in the turbine wheel component rapidly exceeding its surge margin, causing a temporary cease of operation and internal component damage. Shutter Valves can be designed to release this high pressure air before it reaches engine components of the the turbine wheel of the turbocharger, reducing maintenance costs, preventing wear and tear, and prolonging the life of the engine.

2. Description of the Related Art

The most technologically challenging pressure regulation application is the Internal Combustion Engine. Internal combustion engines are designed to provide energy through a flywheel that is turned by a crankshaft. These machines typically power automobiles, boats, airplanes, and other types of motorized vehicles. In the operation of an internal combustion (“I.C.”) engine, a combustible air/fuel mixture is drawn inside a cylinder with the combustion-taking place in the combustion chamber located at the top of each cylinder. In each vessel, a piston, which is connected to the crankshaft through a connecting rod, continuously reciprocates during operation of the I.C. engine. The reciprocation of the piston moving up and down powers the crankshaft. The cyclical movement in an automobile engine is typically termed a “four stroke cycle”. The four strokes of the four-stroke thermodynamic Otto cycle are named according to their respective purpose and include an intake stroke, a compression stroke, a power stroke and an exhaust stroke. In order to maximize the conversion of energy produced from the combustion of fuel into mechanical energy, by the piston turning the crankshaft, combustion occurs within the top of the cylinder, wherein the combustion chamber is effectively sealed during combustion.

The intake and exhaust of gases from an internal combustion engine are controlled by intake and exhaust valves respectively, disposed in fluid communication within the combustion chamber. Accordingly, the vessel head has an intake opening and an exhaust opening for allowing an air/fuel mixture to enter the vessel and for exhaust to exit the vessel after ignition and combustion of the air/fuel mixture. In order to maintain the vessel in a fluid-tight or sealed condition during the compression and power strokes, valves in the vessel head close the intake and exhaust openings. These valves are accordingly referred to as the intake and exhaust valves.

The intake and exhaust valves operate at different times depending on the cycle of the engine. These valves are normally held closed by heavy springs. The purpose of a valve actuating mechanism is to overcome the resistance of the spring to open the valves at the proper time. The valve actuating mechanism includes the engine camshaft, camshaft borrowers or tappets, push rods and rocker arms. The camshaft, which rotates to drive the individual poppet valves, is generally enclosed within the engine block or cylinder head. Shutter Valves have no heavy spring to resist and do not have to scavenge power from the crankshaft, dramatically increasing overall efficiency. In the current configuration, the camshaft has eccentric lobes or cams formed thereon such that each of the cams are specifically disposed and configured for predetermined driving engagement with each valve in the engine. As the camshaft rotates, the cam lobes move up under the valve tappet, thereby exhibiting an upward thrust through the tappet against the valve stem or push rod. This thrust overcomes a valve spring pressure as well as increased pressure within the cylinder and causes the valve to open. When the lobe moves under the tappet, the valve spring reseats the valve resulting in a closing of the valve opening.

During the intake stroke of a four-stroke cycle, the intake valve is opened and the exhaust valve is closed, allowing the air/fuel mixture to fill the cylinder. In the compression stroke of the four-stroke cycle, both the intake and exhaust valves are closed. In the power stroke, both the intake and exhaust valves are closed and a spark generated by the spark plug located inside the cylinder and in direct communication with the combustion chamber serves to ignite the air/fuel mixture initiating the combustion cycle and forcing the piston in a downward direction towards the bottom of the cylinder. In the exhaust stroke of the four-cycle engine, the piston travels upward from the crankshaft and the exhaust valve is opened while the intake valve is closed. The upwardly traveling piston forces the exiting of all the exhaust gases from the vessel. The exhaust gases are a result of the combustion of the air fuel mixture during the previous power stroke. The exhaust gases exit the vessel head through the exhaust manifold. The four-stroke cycle is then repeated numerous times in rapid succession for the powering of the crankshaft, subsequently providing rotational power to the machine.

The duration of the opening and closing of the intake and exhaust valves is fixed, depending on the configuration of the cam lobe which lifts the valve tappets, and accordingly, opens the intake and exhaust valves. The fixed period of time during which the intake and exhaust valves are open is only optimal for one particular revolution per minute (RPM) of the crankshaft. This is generally preset at around 3500 RPMs. However, the amount of the air/fuel mixture, and consequently, exhaust gases, vary depending on the particular RPMs at which the vehicle is operating. The optimal air to fuel ratio is typically recognized as 14.7 parts of air to 1 part fuel. Accordingly, as more fuel is required at higher RPMs, a considerable volume of fuel and air is required to pass through the intake valve. Also, at lower RPMs a relatively small volume of air and fuel is required to pass through the intake valve. However, because the intake valve remains open for a fixed period of time, the air/fuel mixture has a tendency to blow out of the cylinder and pass back into the intake manifold. This phenomenon is known as “blow back”. Therefore, with a pre-defined duration for the valve opening, the intake and exhaust valves frequently stay open too long or not long enough depending upon the RPMs of the engine.

An additional problem associated with the use of poppet valves for the intake and exhaust valves is that they require cavities to be formed within the vessel head creating a dimpled interior within the combustion chamber. Accordingly, when the spark plug generates the spark used to ignite the air fuel mixture, there frequently exists uneven flame propagation and some of the air fuel mixture does not combust. Further, the combustion of the air/fuel mixture results in energy which is directed into the valve cavities and away from the piston. Both of these situations result in an inefficient combustion and a loss of energy from the ignition of the air/fuel mixture within the interior of the combustion chamber.

In the simplest terms, the purpose of the intake and exhaust valves associated with internal combustion (“I.C.”) engines of the type set forth above, is to regulate the flow of gases at the proper intervals into and out of the cylinders of the I.C. engines. The mechanisms responsible for setting the working fluids of an engine in motion are the reciprocating parts, which are more commonly known as the “bottom end”. The “bottom end” includes the crankshaft, connecting rods and pistons of an I.C. engine, as generally set forth above. These parts are attached to one another in a manner that converts linear motion into rotational motion for the powering of the crankshaft. When the “bottom end” is in motion, it pulls and pushes working fluid past the valves by creating vacuum and pressure within the cylinders. The vast majority of reciprocating piston I.C. engines use poppet valves which effectively obstruct and are, therefore, not efficient and restrictive to fluid flow.

The use of poppet valves in reciprocating, I.C. combustion engines dates back to 1876, when Nikolaus Otto in Germany first patented it. They have long been recognized as the most popular valve design for intake and exhaust valves of reciprocating I.C. engines. However, as set forth above, these valves are restrictive to the passage of the working fluid and their use results in a strain being placed on the pistons as they overcome the resistance from the fluid passing over the valve. Also, undesirable behavior of the working fluid occurs because there is a restriction or obstruction placed on fluid flow by the poppet valves as the fluid enters the cylinder. With high valve lift applications, more passage space is given to the working fluid, and the performance of the working fluid improves. This is proven mathematically through the use of equations that allow for predicted calculations of efficiency and power. In addition, poppet valves typically cause the fuel/air mixture to “sprinkler” out into a 360-degree spray having a thickness dependent upon the degree of valve lift. This type of mixture manipulation is not ideal for filling a vessel quickly and efficiently. Poppet valves also require a heavy valve train, take up valuable space beneath the hood of a vehicle and consume more energy during their operation than is otherwise possible with electronic valves, such as Shutter Valves. Accordingly, it is easily recognized that despite their extensive and long term use, poppet valves are not the most efficient means of regulating fluid flow through the intake and exhaust force of an engine.

Therefore, there is a need in the design and operation of reciprocating, internal combustion engines, as well as a variety of other applications, for a valve system comprising intake and exhaust valves for regulating fluid flow to and from a cylinder, which operates more efficiently than conventional valve systems. Shutter Valves would preferably not use the crankshaft for the forced movement of the intake and exhaust valves between an open and closed position so as to increase overall engine efficiency, and more importantly, allow a greater percentage of the engine generated power to be delivered to the flywheel. Further, as less weight and space provides more efficient operation, any such improved valve system would improve the aerodynamics and fuel efficiency of a vehicle by reducing the space required in the design of the hood and engine cavity portions of a vehicle, as well as reducing the overall weight associated with the components used to typically drive conventional valve systems.

### BRIEF DESCRIPTION OF THE DRAWINGS

For a fuller understanding of the nature of the present invention, reference should be had to the following detailed description taken in connection with the accompanying drawings in which:

FIG. 1 is a side view of a Shutter Valve System of the present invention associated with a single pipe and shows partially overlapping and interlocking valve blade features.

FIG. 2 is two views of the shutter valve structure showing from the top view how the interlocking valve blade geometry corresponds to the partially overlapping valve blades.

FIG. 3 is a detailed view of two individual shutter valve blades with a representation of how the valve blades form a seal.

### DETAILED DESCRIPTION OF THE PREFERRED EMBODIMENTS

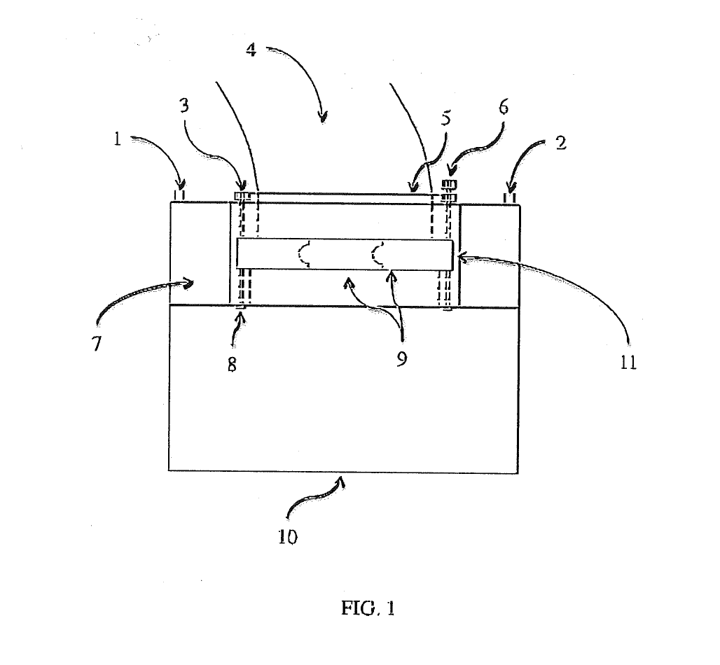

As shown in the accompany drawings, the present invention is directed towards a valve system incorporating at least one Shutter Valve, as indicated generally by reference numeral 11. With initial reference to FIG. 1, the valve system of the present invention is part of a pressure regulation machine, wherein a pipe 4 is attached to the shutter valve 11 to regulate the pressure of the pressurized vessel 10. The shutter valve is operated mechanically in this representation by a gear belt 5, which is attached to blade gear 3, and selectively operated by cam gear 6. The blade gear 3 and cam gear 6 are attached to the shutter valve 11 by the hinge pin 8. The interlocking shutter blades 9 are operated by the above mentioned valve drive assembly and are lubricated by the lubricant contained within the housing 7, in which the lubricant is fed to the system by the inlet port 1, circulated around the retracting interlocking shutter blades 9, the lubricant being removed to a separate tank (not shown) by the outlet port 2.

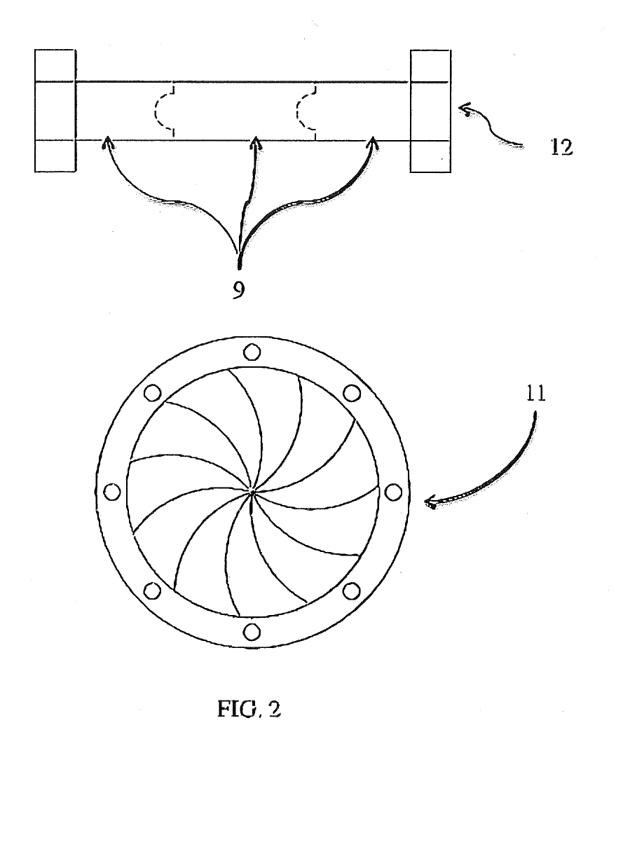

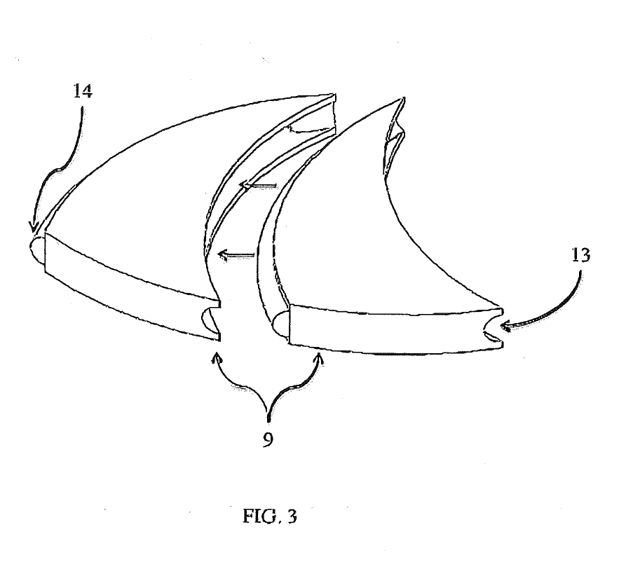

In reference to FIG. 2, a top view and side view of the shutter valve 11 is shown to illustrate the corresponding interlocking valve blades 9 to the geometry of the shutter valve 11. The interlocking shutter valves blades 9 are essential to the proper sealing of the pressurized vessel 10 of FIG. 1 for pressure regulation with the pipe 4, also of FIG. 1. FIG. 3 is a representation of two individual interlocking valve blades 9, showing the female interlocking valve blade feature 13 and the male interlocking valve blade feature 14, to illustrate how when the interlocking valve blades 9 are joined together to form the assembly of the shutter valve 11 of FIG. 2, will form an air tight seal.

With reference now to FIGS. 1, 2 and 3, each of the aforementioned shutter valves 11 comprises a plurality of interlocking valve blades 9, which are movably connected, but more preferably pivotally connected, to a mount 12 that interconnects and movably attaches each of the interlocking valves blades 9 to a support base. Each of the shutter valves 11, represented in FIGS. 1 and 2, may be more precisely defined as a “folding leaf” or “folding blade” shutter valve in that the plurality of interlocking valve blades 9 are preferably, but not necessarily, defined by a plurality of substantially, equally sized leaves or blades pivotally attached and/or interconnected to the shutter valve 11.

In addition, the interlocking valve blades 9 form an aperture or seal by sliding along one another, and arranged in at least partially overlapping and interlocking relation, as shown in both FIGS. 1, 2 and 3. FIG. 2 illustrates the intake shutter valve 11 in a closed position. The open position is defined in each of the shutter valves 11 by a central aperture that has a variable and adjustable diameter and overall dimension. The central aperture therefore defines at least a portion of a flow path of a working fluid, such as high-pressure fluid, passing into and out of the interior of the vessel 10 in direct fluid communication with the pipe 4. The diameter and/or overall dimension of the central aperture is variable by causing relative movement of the plurality of interlocking shutter valve blades 9 in sliding relation to one another, of each shutter valve 11 collectively surround the central aperture, and thereby, define its size as the interlocking shutter valve blades 9 move between the open and closed position. As is readily apparent, the central aperture includes no obstructions therein, and therefore, further defines that portion of the aforementioned flow path of the working fluid to be substantially unobstructed. As shown in FIGS. 1 and 2, the plurality of interlocking shutter valve blades 9 are arranged such that the central aperture is sealed to prevent the escape of fluids.

### SUMMARY OF THE INVENTION

The present invention is intended to address many of the known problems that remain in the art and is directed towards any pressure regulation valve system. More specifically, the valve system of the present invention is preferably, but not necessarily, electronically controlled through the use of a central processing unit (“CPU”) programmed and otherwise structured to provide greater overall machine efficiency through the elimination of the use of mechanical components to drive the valve system.

In addition, the valve system of the present invention preferably comprises a control assembly and, in addition to the computer microchip or CPU, also includes a plurality of sensors structured and disposed to monitor various operating or performance characteristics of the machine, or pressure regulation system in which it is mounted, during the operation thereof The plurality of sensors included as part of the control assembly generate signals back to the central processing unit (CPU) which are indicative of the most current operating/performance characteristics during the operation of the pressure regulation system. In turn, the central processor is designed and structured to generate activating signals to an activation assembly which, as will be described in greater detail hereinafter.

One feature of the present invention is the design and structure of at least specific ones, but preferably all of the valves of the pressure regulation system. Before detailing the operative and structural components and features of the Shutter Valve referred to herein, it is important to emphasize the natural phenomenon of a high-velocity fluid, particularly as it is directed into the vessel of a pressure regulation system. More specifically, a working fluid, when traveling through a conduit or tubing at a high rate of speed possesses momentum, in accordance with Newton's Laws of Physics. To accomplish maximum efficiency in the operation of an improved valve system, such momentum should be disturbed as little as possible during the flow of the working fluid as it is delivered into the vessel. However, and as has been referred to previously herein, the conventional use inferior valves creates a disturbance in the momentum of the working fluid by providing a direct obstruction in the path of fluid flow. In comparison with Shutter Valves, current valve configurations do not offer the low weight, compactness, unobstructed flow path, pressure chamber design freedom, the ability to operate electronically and controlled by software logic, or infinite aperture adjustability. Shutter Valves demonstrate their superiority in many different ways and will become the new gold standard of valve design.

Accordingly, to better realize the full potential of an pressure regulation system and maximize its efficiency, it is necessary to provide a substantially unobstructed, free flow valve system which does not disturb the inherent momentum of fluid flow by eliminating any obstruction along the length of the flow path or at the point of delivery to the vessel. A Shutter Valve allows for improved pressure chamber design freedom for the optimization of fluid or combustion propagation.

Therefore, the valve system of the present invention incorporates the use of one or more Shutter Valves as a means for providing a working fluid with little to no resistance as it travels along a predefined path of fluid flow and as it is delivered into the vessel. More specifically, the Shutter Valve structure of the present invention preferably comprises what is typically referred to as a “folding leaf” or “folding blade” valve, with interlocking features, unique to this, patent, to form an airtight seal, which is potentially electronically operated and computer controlled for accomplishing precise timing and positioning in order to adjustably vary the size of an aperture formed within each Shutter Valve, when in an open position. A substantially unobstructed, free flow of fluid is thereby provided as the working fluid travels along its flow path and is delivered into the interior of a vessel. Each Shutter Valve of the valve system of the present invention comprises a plurality of valve elements, which may be defined as interlocking “valve leaves” or “valve blades”, movably or more specifically pivotally attached to a support frame or base and sliding in operation, in at least partially overlapping relation to one another and which are collectively movable in substantially opposite directions to accomplish the opening or closing of the Shutter Valve structure. When in the open position, the central aperture is formed and the diameter and geometry of the central aperture may be adjustably varied so as to regulate fluid flow there through. The perimeter or circumference of the central aperture is defined by the correspondingly positioned peripheral edges of the valve components that surround the central aperture. As set forth above, each pressure regulation system comprises at least one Shutter Valve, independently controlled by the aforementioned control assembly defined, at least in part by a central processing unit and a plurality of sensors which are disposed and structured to deliver sensor signals to the central processing unit indicative of predetermined, operating or performance characteristics of the pressure regulation system.

Further, the valve system of the present invention may also include an activation assembly potentially in the form of an electronically regulated and powered drive motor(s) interconnected, by any applicable means, to the plurality of valve elements. The drive motor regulates the timing and positioning of the plurality of valve elements by selectively orientating each Shutter Valve between an open position and a closed position and also determines the precise, variable adjustment of the size of the central aperture of each of the Shutter Valves to maximize performance and efficiency.

Now that the invention has been described,

What is claimed is:

1. A valve system designed for regulating fluid flow into and out of a vessel of a pressure regulation system, said valve system comprising:
a) a valve assembly including a Shutter Valve with at least an intake valve and an exhaust valve each disposed in fluid communicating relation to the vessel,
b) a Shutter Valve including a centrally disposed aperture of adjustable dimension,
c) an activating assembly connected to said valve assembly and structured to position said Shutter Valve between an open position and a closed position, and
d) a control assembly connected in regulating relation to said activating assembly and structured to determine positioning of said Shutter Valve dependent on operating characteristics of the pressure regulation system

2. A valve system as recited in claim 1 wherein said Shutter Valve comprises a base, a plurality of valve elements mounted on said base in sliding, at least partially overlapping and at least partially interlocking, and said plurality of valve elements collectively surrounding said central aperture when said Shutter Valve is disposed in said open and closed position.

3. A valve system as recited in claim 2 wherein said central opening at least partially defines a path of fluid flow communicating with the pressure regulation system; said activating assembly cooperatively structured to regulate the dimension of said central aperture and relative movement of said plurality of valve elements.

4. A valve system as recited in claim 1 wherein said Shutter Valve comprises a base, a plurality of valve elements movably mounted on said base in sliding, at least partially overlapping relation to one another and at least partially interlocking, said plurality of valve elements disposed in a substantially annular array and collectively surrounding said central aperture when said Shutter Valve is disposed in said open position.
A valve system as recited in claim 2 wherein said central opening at least partially defines a path of fluid flow communicating with the vessel; said activating assembly and said control assembly cooperatively structured to regulate the dimension of said central aperture and relative movement of said plurality of valve elements.

5. A valve system as recited in claim 2 wherein said plurality of valve elements are defined by a plurality of folding blades each pivotally mounted on said base in at least partially overlapping relation to one another and at least partially interlocking, in collectively surrounding relation to said central aperture and a flow of fluid passing there through.

6. A valve system as recited in claim 1 wherein said control assembly comprises a central processing unit connected in regulating relation to said activating assembly and structured to control positioning of said Shutter Valve between said open and closed positions.

7. A valve system as recited in claim 5 wherein said control assembly further comprises a plurality of sensor structures each connected to the pressure regulation system and structured to collectively generate a plurality of sensor signals indicative of predetermined operating characteristics of the pressure regulation system.

8. A valve system as recited in claim 6 wherein said central processing unit is responsive to said plurality of sensor signals and structured to generate activating signals to said activating assembly to selectively regulate positioning of said Shutter Valve dependent on indicated operating characteristics of the pressure regulation system.

9. A valve system as recited in claim 7 wherein said Shutter Valve comprises a base, a plurality of valve blades movably mounted on said base in sliding, at least partially overlapping relation to one another and at least partially interlocking, said plurality of valve blades disposed in a substantially annular array and collectively surrounding said central aperture when said Shutter Valve is disposed in said open position.

10. A valve system as recited in claim 8 wherein said activating assembly comprises an electrically powered drive motor drivingly interconnected to said Shutter Valve and structured to concurrently position said plurality of valve blades between said open and closed positions.

11. A valve system as recited in claim 9 wherein said Shutter Valve defines said intake valve.

12. A valve system as recited in claim 10 wherein said central aperture at least partially defines a path of fluid flow to the vessel; said activating assembly and said control assembly cooperatively structured to regulate the size of said central aperture and relative movement of said plurality of valve blades.

13. A valve system as recited in claim 1 wherein each of said intake and exhaust valves comprises a Shutter Valve.

14. A valve system as recited in claim 12 wherein each of said Shutter Valves comprises a base, a plurality of valve elements movably mounted on said base in sliding, at least partially overlapping relation to one another and at least partially interlocking, said plurality of valve elements disposed in a substantially annular array and collectively surrounding a central aperture when said Shutter Valve is disposed in said open position.

15. A valve system designed to regulate fluid flow between a vessel and intake and exhaust ports of a pressure regulation system, said valve system comprising:
a) a valve assembly including an intake valve and an exhaust valve disposed in fluid regulating relation between the vessel and the intake and exhaust ports respectively,
b) each of said intake and exhaust valves comprising a Shutter Valve,
c) each of said Shutter Valves comprising a plurality of at least partially overlapping and interlocking valve elements pivotally mounted in sliding relation to one another and collectively disposable between an open position and a closed position, and
d) said open position of each Shutter Valve comprising a single, central aperture of adjustable dimension disposed to define a substantially unobstructed path of fluid flow between the vessel and corresponding ones of the intake and exhaust manifold.

16. A valve system as recited in claim 14 wherein said plurality of valve elements of each of said Shutter Valves are disposed exteriorly of the vessel when in said open and closed positions.

17. A valve system as recited in claim 15 wherein each of said Shutter Valves comprises a base connected in supporting relation to said plurality of valve elements, said plurality of valve elements pivotally connected to said base in collectively surrounding relation to said central opening and concurrently movable in a substantially annular array to regulate the dimension of said central aperture and a path of fluid flow there through.

18. A valve system as recited in claim 16 further comprising a control assembly including a central processing unit interconnected in regulating relation to said valve assembly and responsive to operating characteristics of the pressure regulation system to regulate positioning of each of said Shutter Valves.

19. A valve system as recited in claim 17 wherein said control assembly comprises a plurality of sensor structures each connected to the pressure regulation system and structured to collectively generate a plurality of sensor signal indicative of predetermined operating characteristics of the pressure regulation system.

20. A valve system as recited in claim 18 further comprising an activating assembly interconnected between said control assembly and said valve assembly and in driving relation to each of said Shutter Valves independently of one another.

21. A valve system as recited in claim 19 wherein said central processing unit is responsive to said plurality of sensor signals and structured to generate activating signals to said activating assembly to selectively regulate independent positioning of each of said Shutter Valves dependent on indicated operating characteristics of the pressure regulation system.
